(19) United States
(12) Patent Application Publication
(10) Pub. No.: US 2020/0300683 A1
(43) Pub. Date: Sep. 24, 2020

(54) Cup Printing Method

(71) Applicants: Robert Corley, Cleveland, TN (US); Elmer William Stout, JR., Fairway, KS (US)

(72) Inventors: Robert Corley, Cleveland, TN (US); Elmer William Stout, JR., Fairway, KS (US)

(21) Appl. No.: 16/897,550

(22) Filed: Jun. 10, 2020

Related U.S. Application Data
(62) Division of application No. 15/280,228, filed on Sep. 29, 2016.
(60) Provisional application No. 62/238,924, filed on Oct. 8, 2015.
(60) Provisional application No. 62/259,225, filed on Nov. 24, 2015.

(51) Int. Cl. G01F 19/00

(52) U.S. Cl. CPC G01F 19/00

(57) ABSTRACT

An opaque cup has an inside measuring system having at least first and second scales viewable inside the cup. The first scale is preferably located in a bottom half of the volume of the cup and the second scale is located in a top half of the volume of the cup. Some cups may just have the first or second scale, some may have both, whether they be linearly aligned, or disposed angularly relative to one another, such as 180 degrees from one another.

### CLAIM OF PRIORITY

This application is a divisional application of U.S. patent application Ser. No. 15/280,228 filed Sep. 29, 2016, which claims the benefit of U.S. Patent Application Nos. 62/238,924 filed Oct. 8, 2015, and 62/259,225 filed Nov. 24, 2015, all of which are incorporated by reference herein in their entirety.

### FIELD OF THE INVENTION

The present invention relates to an improvement for opaque cups and more particularly an improvement for use in providing multiple pours of relatively precise amounts of liquid into a cup, particularly for drinking as could benefit various industries, such as alcoholic beverages (alcohol and mixers, etc.) as well as coffee style drinks (coffee, cream and/or flavoring) and others.

### BACKGROUND OF THE INVENTION

When providing coffee cups to the marketplace coffee cups are normally opaque cups as they typically have some type of insulating property; possibly directly or indirectly with a sleeve. Additionally, plastic cold beverage cups are often opaque.

Certainly there are transparent measuring cups available in the marketplace for use principally in cooking. These measuring cups are not typically single use cups but are understood routinely made of glass, metal or ceramic. These transparent cups have a scale routinely viewable from outside the measuring cup. Once fluid is measured, it is then poured into another container.

U.S. Published Patent Application 2002/0029635 is directed to a single use measuring cup but that reference appears to describe a transparent structure as well.

U.S. Published Patent Application No. 2004/0027502 relates to a transparent and non-transparent disposable coffee cups. The 2004/0027502 published patent application is incorporated herein by reference in its entirety. The '502 application recognizes a need to provide a fill line and possibly leave additional room for a standard amount of cream. FIGS. 1C and 2C of the '502 Schwartz published application describe and show printed lines for increments of adding cream to coffee such as in one ounce or two ounce increments. However, only a few preselected amounts of additional liquid could be selected utilizing the methodology taught and suggested by this application. Specifically, the applicant shows four interior positions to which the volume of the coffee could then be filled and the possibility of adding cream thereto.

While the '502 published application is certainly a step in the right direction, it is not believed to go far enough to satisfy specific situations demanded by various companies that purchase coffee cups and certainly doesn't satisfy all potential uses for hot or cold drinks.

### SUMMARY OF THE INVENTION

Accordingly, it is an object of a presently preferred embodiment of the present invention to provide an improved cup for use in various applications.

It is also an object of many embodiments of the present invention to provide a non-transparent cup for use in many applications.

It is an object of many embodiments of the present invention to provide an improved single use cup for many applications having printed indicia there inside representing at least two if not a plurality of fill levels.

It is another object of many embodiments of the present invention to provide at least two different sets of scales internal to a cup separated by at least a half full indication.

It is another object of many embodiments of the present invention to provide a least two sets of fill indicia or scales, one at a bottom half and one at a top half for either first adding a first substance such as cream to a certain amount and then filling the coffee on one scale and/or alternatively to fill first with a set amount of a larger amount of liquid such as coffee and then a smaller amount of another liquid such as cream to a desired amount, or both. Some embodiments may have these two scales arranged on the same side of the cup, such as linearly, or arranged otherwise while other embodiments may have one scale 180 degrees out phase of the other scale, viewable inside an opaque cup.

Another object of many embodiments of the present invention to provide at least one of printed indicia as scales internal to a cup relating to one of an amount of cream, coffee, alcohol or mixers and/or other liquids added to the cup for various uses.

Accordingly, in accordance with presently preferred embodiments of the present invention, a first embodiment proposes adding cream (or other additive(s)) first and then the coffee. There would be no way to identify how much cream was initially added with the Schwartz reference, particularly when a common total fill line is utilized for the beverage regardless of whether or not cream was added or not.

Accordingly, for many preferred embodiments, two separate scales are provided interiorly viewable in cups. A first scale can be printed or embossed on a lower half of an intended fill volume of the cup, and a second scale can be printed above the half. The first scale could relate to a smaller amount poured first, and then a larger amount second, while a second scale could relate to a larger amount poured first and then a smaller amount poured second. This could be beneficial for keeping consistent pours in establishments or companies that sell filled cups having at least one of hot or cold beverages. For instance, such beverages as coffee, tea, mixed drinks, hot chocolate, apple cider and/or other beverages that could require mixing of solutions in the cup could benefit from having the scales viewable inside the cup by employees or individuals filling the cups. The methodology described here could apply to any size cup such as from six ounces or potentially even less to up to or more than 64 ounces by way of example. While measuring cups are certainly used throughout the industry and in kitchens throughout the world, this is believed to be more difficult to first fill a measuring cup to the desired amount and then pouring into a drinking cup.

By providing one or more scales internal to a drinking cup, particularly a disposable drinking cup, at least one step can be taken out of the process particularly with disposable paper or plastic cups which do not traditionally have printed measurement or indicia internal thereto, with the exception of the Schwartz '502 reference, which certainly can be improved upon as described herein. Of course, a more permanent cup, such as stainless steel, porcelain or other more permanent plastic or other more permanent cup, could have some features described herein.

Not only can standard liquid measurement volume increments be indicated such as ounces, multiples of ounces, fractions of ounces, milliliters, centiliters or other amounts be provided, but also potentially custom units of measurements could also be printed such as one or two creams to the extent they have repeatable volume at least for a particular establishment. Additionally, more “descriptive” amounts might be utilized such as stout, crisp, light, easy, smooth, balanced or other wording related to a measurement which could be repeatable for at least a particular individual and/or establishment. Ratios could be utilized such as a 1 to 5 cream to coffee ratio for a “crisp” pour as opposed to a 0 to 5 ratio for a black pour or other amount.

By providing two scales for at least some embodiments relative to the half volume or intended fill volume of the cup, one would have the option of providing one or more additives first and then the main beverage or alternatively providing the main beverage first and then the additive liquid(s). Two scales could be provided, possibly above one another or near one another or the same general area of the cup or in different areas, possible even 180 degrees out of phase internal to the cup. Not only could individuals benefit from such use in their homes or vehicles or other locations such as, but not limited to while camping or at parties, etc . . . , those that provide beverages to customers such as fast food restaurants, coffee shops and others could benefit by reducing a step in the process to thus save product and cleaning costs. Consistency in beverages could be a benefit desired by consumers. Printed scales of the presently preferred embodiment could be provided. Molded scales could also be provided. Additionally, when printing, it is anticipated that the printing could be with a food grade ink, preferably FDA approved, and then possibly covered with a coating such as polyethylene or other appropriate coating so as to prevent bleeding of the ink into the drink particular with hot drinks such as coffee which may be an elevated temperature which may otherwise tend to dissolve the ink.

While paperboard coffee cups are certainly one preferred embodiment, of course styrofoam and/or other hot drink disposable cups or non-disposable cups could be utilized as well as plastic and/or thermoformed and/or injection molded cups which may be directed to either or both of hot and/or cold drinks. Once again at least the first and second scales are preferably provided relative to half fill volume for many embodiments. The scales also need not be completely separate but could be adjoining in a single sided embodiment. However, unlike a measuring cup, the scales are printed to be viewed interior to the cup and relate to the mixing of the product within the cup as opposed to dispensing from the measuring cup into another volume. Additionally, internal to the cup different scales can be provided on opposite sides such as half ounce increments on one side and 1½ ounce increments and/or other liquid volume measurements whether tied to a traditional volumes or custom volumes as described above.

### BRIEF DESCRIPTION OF THE DRAWINGS

The particular features and advantages of the invention as well as other objects will become apparent from the following description taken in connection with the accompanying drawings in which:

FIG. 1 is a front perspective view of a cup of a presently preferred embodiment of the present invention;

FIG. 2 is a cut-away view of line A-A or the first embodiment of the cup shown in FIG. 1;

FIG. 3 is a cross sectional view taken along the line A-A of a first alternatively preferred embodiment of the present invention;

FIG. 4 is a cross sectional view along the line B-B of FIG. 1 of the first alternatively preferred embodiment;

FIG. 5 cross-sectional view of a second alternative view of the preferred embodiment taken along line A-A of FIG. 1; and

FIG. 6 is cross-sectional view taken along B-B of FIG. 1 or FIG. 3.

### DETAILED DESCRIPTION OF THE PREFERRED EMBODIMENTS

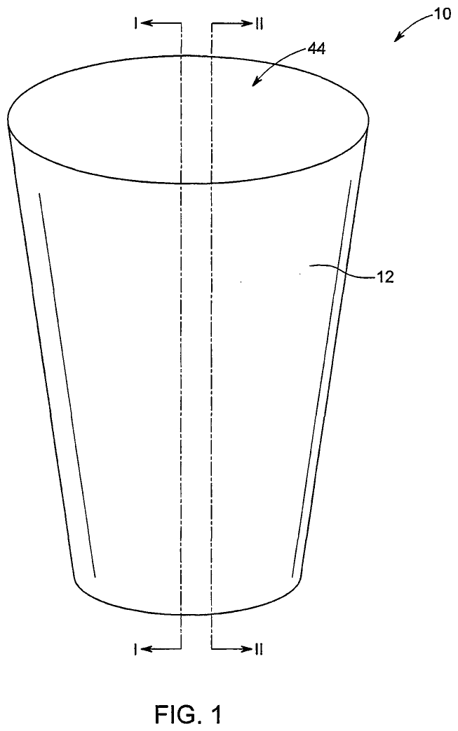

FIG. 1 is front perspective view of a cup 10 of the presently preferred embodiment of the present invention. Cup 10 may be a paperboard cup traditionally used for serving coffee such as at coffee shops, fast food restaurants and/or other locations. Other materials may be utilized to construct the cup as well whether they be plastic, Styrofoam, or other single use style cups made of various techniques for hot and/or cold drinks. Multiple use cups such as plastic, metal, ceramic and/or other materials may also be utilized for cup 10.

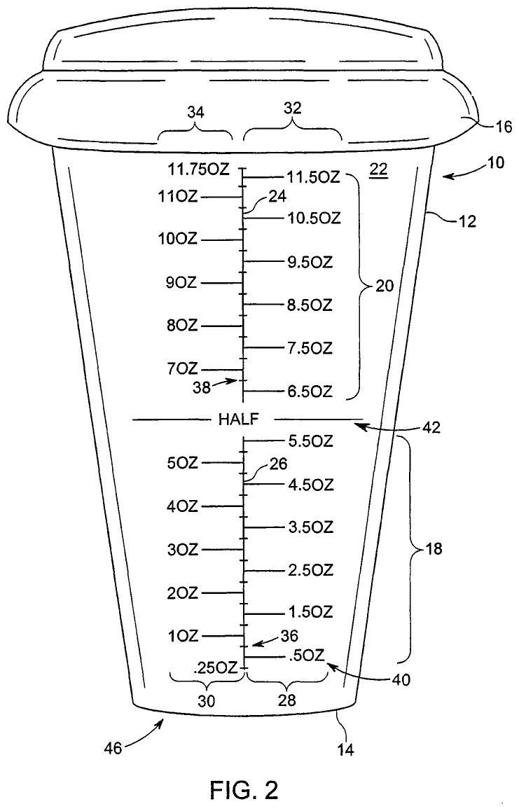

Cup 10 may have various sizes whether small such as six ounce or larger (or even smaller) or up to 64 ounces (or even larger). Cup 10 is opaque through its side walls 12 as well as through its bottom 14 as can be seem with reference to FIG. 2.

A cap or lid 16 is shown in FIG. 2 which certainly could be optional for many embodiments.

FIG. 2 shows a presently preferred embodiment of the present invention in the form of a first scale 18 and a second scale 20 both of which are printed on an interior surface 22 of the sidewall 12 of the cup 10. In fact, the first and second scales 18,20 are shown linearly arranged as it relates to longitudinal markings 24,26 (if used) of the scales 18,20. First and second sets of lateral markings 28,30 as well as 32,34 for at least some first and second scales 18,20 (if used) respectively can be utilized in various ways as will be described herein. Specifically, the first set 28,30 could be utilized to mark half-ounce increments or other specific incremental measurements whether they be full ounce, milliliter fractional ounce, or other indicia while the second sets 30,34 if utilized could indicate whole ounce or other increments. Quarter ounces or other fractional portions could be marked with intermediate markings 36,38 which certainly could be optional and/or possibly unlabeled as shown. Also, instead of utilizing traditional volume measurements such as ounces as shown on label 40, created volume indicia such as precise, strong, light, stout, crisp, easy, smooth, and balanced could be selected for various drink options whether it be coffee and/or tea or possibly even mixed drink options which could also include such markings as single shot, double shot, as seen as a single, double, triple, shot, and/or other markings.

For some embodiments, a first half volume indication 42 is provided with the first half volume indication 42 indicating at least one of a half volume of the cup 10 and/or a half of an intended fill volume of the cup 10. It may be that the cup 10 is a 12 ounce cup that actually holds 12½ ounces whereby the half volume indication 42 may be one of 6 or 6¼ ounces as provided by way of example. Some cups may hold exactly 12 ounces of inside the cavity 44 as defined by the cup 10 having continuous sidewalls 12 with bottom 14 closing the bottom 46 of the cup body thereby assisting in defining the cavity 44 above the cup bottom 14 to retain liquid volume while being surrounded by the sidewalls 12.

Other scales 16,20 may have only one of longitudinal markings 24,26, if either. Still other scales may have a single or multiple indicia markings 28,30 or 32,34 as a portion of a scale 18,20.

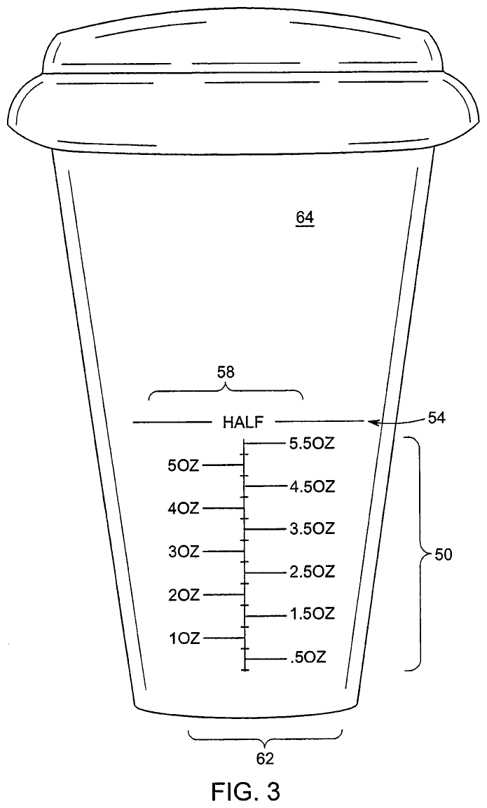

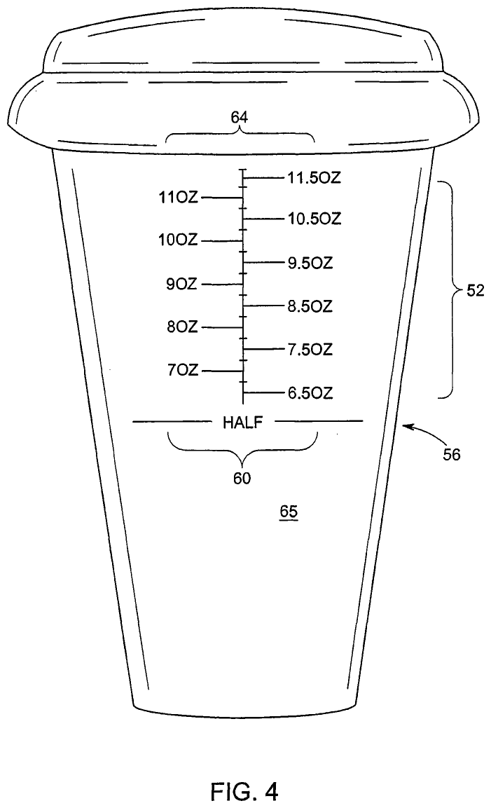

While the longitudinal markings 24,26 are shown linearly lined in FIG. 2, they certainly could be angularly disposed relative to one another or even shown about the internal surface 22 of the cup such as shown in reference to FIGS. 3 and 4 which are shown on 180 degrees out of phase with each other as would be understood with reference to FIG. 1 in that cross-sectional view is oriented toward the left and cross-section B-B is oriented to the right and therefore when put together as shown in FIG. 1 the first scale 50 would be 180 degrees from the second scale 52.

Scales 50,52 can be identical or different from those shown in FIG. 2. It is interesting to note that the first half volume indication 54 could then be opposite a second half volume indication 56 if both are used. Also, the half volume indications 42,54,56 are shown extending widths 58,60 beyond a width 62,64 of the respective first and second scales 50,52 for at least some embodiments. Also the various first half volume indications 42,54 as well as second volume indication 56 are oriented to be read on the internal surface of the sidewall 22,64. Accordingly as would be understood from the view of FIG. 3 and FIG. 4, the second half volume indication 56 is spaced form the first half volume 54 for at least some embodiments although a continuous half volume indication could be circumscribed circumferentially around the interior surface 64 of the cup 10 for at least some embodiments.

One will further observe from the embodiments of FIG. 3 and FIG. 4, the first half and the second half volume indications 42,54 are symmetrically disposed 180 degrees relative to one another. Also for two embodiments represented by FIGS. 2 and 3-4 have the first half volume indication on the bottom half portion of the cavity 44 while the second scale 20,52 are shown on the top half of the cavity 44 (i.e., the first scale 18,50 is shown below the first as well as the second half volume indication while the second scale 20,52 is shown above the first half volume indication 42 and second half volume indication 54 to the extent either one are provided.

Additionally, with reference back to the embodiments of FIGS. 3 and 4, the first scale 50 is angularly disposed relative to the second scale 52 internal to the cavity 44 of the cup 10. (180 degrees to be precise although other angle of orientations could be provided in other embodiments even linearly disposed as is shown in the embodiment of FIG. 2.) Accordingly, with reference back to the embodiment of FIG. 2, the second scale 20 could be directly above the first scale 18 and the first scale 18 could be directly below the second scale 20 as would be understood by those of ordinary skill in the art.

Once again although the labels 40 show ounces, they certainly could be whole ounce increments on either the first or the second sides 28,32 as well as 30,34 and/or fractional ounce increments, metric measurements, other volume measurements and/or created volume measurements. Dry measurements could be provided such as for mixing some beverages, like hot chocolate mix with water or milk, etc. for at least some embodiments.

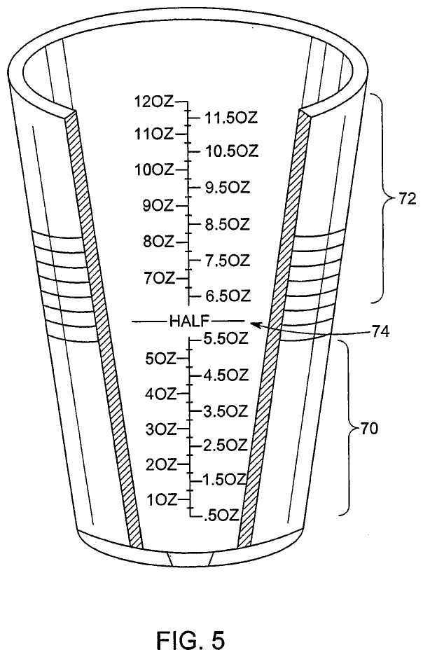

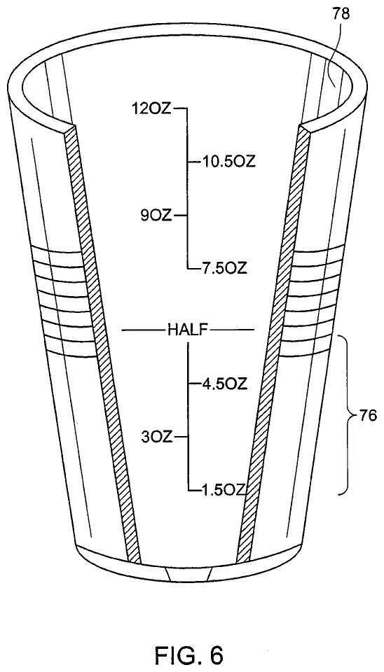

It is anticipated for many embodiments that the scales 18,20,50,52 as well as 70,72 separated by first half indications 74 in the embodiment of FIG. 5 as well as first scale 76 shown in FIG. 6 can be printed with an FDA approved food grade ink possibly also covered with a coating such as a heat endurable coating 78 to withstand the temperatures of a coffee, tea or other hot beverages such as polyethylene or other appropriate material which is an FDA approved coating so as to assist in the scales 18,20,50,52,70,72,76 being resistant to bleeding or deleting due to the hot beverage inserted into the cup 10. Polyethylene may be an acceptable coating for many embodiments. As shown in FIG. 5, the first and second scales 70 can be connected such as through the half volume indication 74 or not with reference to FIG. 2-4.

Some embodiments may provide on a first side of the cup 10 the first and second scales 70,72 on an opposite side of the cup 10 as the first scale 76 which could also be a third scale. This could have various advantages such as being able to provide a multi-use cup 10 which could not only be utilized for various hot beverage applications but also various other applications particularly if the cup 10 is capable of holding both hot and cold beverages due to its construction.

Additionally, the scales 18,20,50,52,70,72,76 could be embossed into or from the internal surfaces 22,64 etc. of the various cup embodiments 10 so as to be readable from internal to the cup 10 as would be understood by those ordinarily skilled in the art.

Various manufacturers' techniques could be utilized for paper or paperboard cups as well as plastic cups whether they be thermoformed with or without IML (in mold labeling) or provided as a disposable or reusable cup. Various manufacturing techniques and/or materials can be utilized for various embodiments of cup 10.

It will also be obvious to one of ordinary skill that the scales 18,20,50,52,70,72,76 can be provided and/or adjusted to a specific customer's needs and/or desires or that of the manufacturer. Some may prefer to have different increments for preferred design such as whole ounces, half ounces, fractional ounces whether they be less than an ounce or more than an ounce, i.e., half ounce, 2.5 ounce, etc. Also, some may want a scale that goes to various size whether they are 9 ounce, 6 ounce, 24 ounce, or more.

Multiple dynamic pouring or filling options can be provided with the cup of the presently preferred embodiment. Specifically, the cup 10 can accommodate the preference of either adding additional liquid before or after the main beverage is poured. By this purpose and benefit of allowing customers the ability of efficiently and precisely pour additional liquids into their cup 10 without using additional measuring utensils or cups can be accommodated. This can be beneficial for keeping consistent pours in an establishment or to an individual and/or by companies that sells cups for hot or cold beverages. Beverages that could benefit from these improved cup 10 could be those that provide coffee, tea, mixed drinks, hot chocolate, apple cider, or virtually any other beverage that could benefit from having measurements of additional add-ins utilized with a main beverage. In fact, dry measurements could be accommodated such as by providing dried hot chocolate mix to then be accommodated by a certain volume of water there on top, etc.

Virtually any size cup from as small as you would like to use, typically about 6 ounces, but certainly smaller cups could be accommodated up to a 64 ounce as would appear unlikely that anyone would be drinking a mix drink in excess of 64 ounce or certainly not a cup of coffee exceeding 64 ounces for most embodiments although there may be specific circumstances in which greater than a 64 ounce cup may be desired. The methodology described herein for manufacturing cups could be adopted to the total ounce cup 10 and allow relative consistency for the customer and/or consumer as it relates to knowing what they are going to likely taste when they make a desired mix.

Cups 10 of the presently preferred embodiments take the step of utilizing a measuring cup out of a mix by providing the ability to utilize the cup 10 in at least one of two different ways. For some users, they may desire to provide the additive first whether that be cream or flavoring for coffee which could be provided in half ounce or other increments and then filled to a desired fill level utilizing the first scale and then filled to a desired fill level utilizing the second scale. This allows for the precise addition of cream or other liquid added to the beverage. Certainly more than one additive whether that be a cream or a liquor or a flavoring or other additive could be added in relatively precise amount such as if 1½ ounces of cream were added utilizing the first scale certainly another ½ ounce of flavoring such as vanilla or other flavoring, could then be added as well if so desired. Then the total amount of coffee or other main beverage could be added on top thereof to reach 10 or 11 ounces in a 12 ounce cup so as to not overflow the cup 10. Dry additives could be added, preferably before liquids as well. Still others may prefer to provide the main beverage first, i.e., knowing that they are going to end up with an 11 or 11½ ounce beverage, they may fill to 10 ounce and then add an ounce of cream and ½ ounce of flavoring and/or other combinations of mixtures so as to ideally not overflow the cup 10.

Accordingly, regardless of the methodology of how the cup 10 is filled, the consumer or those utilizing the cup 10 can have the ability to provide consistent pours as it relates to the ordered pour. Some may desire to turn the cup as pours are made from different stages, i.e. it may be desirable to first add the additives up to a certain amount on the first scale 18 and/or 50 and then turn the cup to then provide the main beverage up to a desired amount. Other embodiments need not be turned. Some materials may be more difficult to print than others and thus various ways of marking the scales 18,20,50,52,74,76 can be accommodated in various embodiments.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A method of printing at least one scale on an inside surface of a cup comprising the steps of:
(a) providing a cup having an opaque cup body formed with continuous sidewalls, and
a cup bottom closing the bottom of the cup body to define a cavity for retaining a liquid volume above the bottom surrounded by internal surfaces the sidewalls; and
(b) printing a first scale and a second scale on the internal surfaces of the sidewalls with the first scale located in a bottom half of the cavity and the second scale located in a top half of the cavity.

2. The method of claim 1 wherein during the step of printing a first half volume indication is printed to be read on the internal surface of the sidewall.

3. The method of claim 2 wherein during the step of printing a second half volume indication spaced from the first half volume indication is printed.

4. The method of claim 3 wherein during the step of printing the second half volume indication is symmetrically disposed 180 degrees relative to the first half volume indication.

5. The method of claim 4 wherein during the step of printing the first scale is printed below the first half volume indication and the second scale is printed above the second half volume.

6. The method of claim 2 wherein during the step of printing the first scale is printed below the first half volume indication and the second scale is printed above the second half volume indication.

7. The method of claim 2 wherein during the step of printing the first scale is printed below the first half volume indication and the second scale is printed above the first half volume indication.

8. The method of claim 7 wherein during the step of printing the second scale is angularly spaced relative to the first scale about the internal surfaces of the sidewalls.

9. The method of claim 8 wherein during the step of printing the second scale is symmetrically disposed 180 degrees relative to the first scale about the internal surfaces of the sidewalls.

10. The method of claim 7 wherein during the step of printing the first scale is printed directly below the first half volume indication.

11. The method of claim 1 wherein during the step of printing the cup is one of paperboard, plastic, Styrofoam, metal, and ceramic.

12. The method of claim 1 wherein during the step of printing the first scale and the second scale have liquid measurement indications in one of whole ounce increments, fractional ounce increments, metric volume measurements, and created volume measurements.

13. The method of claim 1 wherein during the step of printing the first and second scales are one of printed with an FDA approved food grade ink and formed into the sidewalls of the cup.

14. The method of claim 13 wherein after the step of printing, further comprising the step of covering the first and second scales with a coating.

15. The method of claim 14 wherein during the step of coating a polyethylene coating is applied.

16. The method of claim 12 wherein during the step of printing the created volume measurements are selected from the group of precise, strong, light, stout, crisp, easy, smooth and balanced.

17. The method of claim 2 wherein during the step of printing the first and second scales are connected through the first half volume indication.

18. The method of claim 2 wherein during the step of printing the first half volume indication extends laterally about a circumference of the internal surface of the sidewalls a greater length than at least one of the first and second scales.
